(19) United States
(12) Patent Application Publication
(10) Pub. No.: US 2026/0313287 A1
(43) Pub. Date: Oct. 8, 2026

(54) Loudspeaker drive unit

(71) Applicant: Genelec Oy, Iisalmi (FI)

(72) Inventors: Jussi Väisänen, Iisalmi (FI); Pietu Borén, Iisalmi (FI); Noa Eskelinen, Iisalmi (FI)

(21) Appl. No.: 19/483,633

(22) PCT Filed: May 10, 2024
(86) PCT No.: PCT/FI2024/050226

§ 371 Date: Nov. 12, 2025

(30) Foreign Application Priority Data
May 12, 2023 (FI) 20235542

(51) Int. Cl. H04R 1/24; H04R 1/26; H04R 7/12; H04R 7/16; H04R 9/06

(52) U.S. Cl. CPC H04R 1/24; H04R 1/26; H04R 7/12; H04R 7/16; H04R 9/06

(57) ABSTRACT

According to a first aspect of the present disclosure, there is provided a loudspeaker drive unit having a frame, which features an outer frame section and an inner frame section, which defines an opening. The loudspeaker drive unit also features a lower frequency transducer. The lower frequency transducer has a diaphragm, which is suspended between the outer frame section and the inner frame section so as to form a waveguide. The loudspeaker drive unit further features a compression transducer as a lower frequency transducer attached to the inner frame section.

### FIELD

The present disclosure relates to devices for sound reproduction. In particular, the disclosure relates to a compound drive unit with a high-frequency drive unit provided coaxially within a mid-frequency driver.

### BACKGROUND

In pursuit of natural and uncoloured sound reproduction loudspeakers are generally designed to produce only the frequencies intended to be reproduced. While it is important to achieve response curve that is as flat as possible, it is equally desirable to provide for a driver with stellar directivity properties for the purpose of producing a clear sound image in the intended listening location. A clear sound image is produced when the sound waves are propagated to a focused location in wide frequency band. This means that low, mid, and high frequency bands are all emitted to the same direction with minimal scattering. However, good directivity typically comes with a trade-off in the physical size of the drive unit as it is difficult to construct an effective waveguide with a small baffle.

US 2018/0324527 A1 discloses a compound loudspeaker drive unit featuring a domed driver as a higher frequency transducer arranged coaxially within a lower frequency.

US2017111729 A1 and US2017048610 A1 disclose two examples of compound loudspeaker drive units featuring a compression driver as a higher frequency transducer arranged coaxially within a lower frequency.

There is therefore a need for a loudspeaker drive unit with great directivity but small form factor.

### SUMMARY

The invention is defined by the features of the independent claims. Some specific embodiments are defined in the dependent claims.

According to a first aspect of the present disclosure, there is provided a loudspeaker drive unit having a frame, which features an outer frame section and an inner frame section, which defines an opening and which comprises a throat, which forms part of a waveguide. The loudspeaker drive unit also features a lower frequency transducer. The lower frequency transducer has a diaphragm, which is suspended between the outer frame section and the inner frame section with an outer suspension element and an inner suspension element, respectively, so as to form part of the waveguide. The loudspeaker drive unit further features a compression transducer as a higher frequency transducer attached to the inner frame section.

Certain embodiments of the loudspeaker drive unit may include one or more than one features from the following itemized list:
the higher frequency transducer is mounted to the rear of the inner frame section;
the throat defines an opening;
an output opening of the higher frequency transducer is aligned with the opening of the inner frame section;
the throat comprises a surface, which forms part of the waveguide;
the throat, the suspension elements, and the diaphragm are tangentially aligned;
the throat exhibits an outwardly flaring waveguide surface,
the waveguide surface is continuous with no axial protrusions exceeding 1 mm,
distance between the higher frequency transducer and the lower frequency transducer along the acoustic axis is equal to or more than the axial extension of the diaphragm of the lower frequency transducer along the acoustic axis of the drive unit,
the acoustic axes of the higher frequency transducer and lower frequency transducer are aligned,
the outer suspension element and the inner suspension element suspend the diaphragm of the lower frequency transducer to the frame,
the outer suspension element and the inner suspension element form part of the waveguide,
the outer suspension element and the inner suspension element are not directly driven by a voice coil.

Considerable benefits are gained with aid of the novel concept. By constructing the higher frequency transducer as a compression driver the throat on the inner frame member may be shaped relatively deep in the dimension defined by the acoustic axis of the higher frequency transducer. It follows that the directivity properties of façade surface of the throat may maximized. This, in turn, means that the waveguide formed by the diaphragm assembly of the lower frequency transducer and the inner frame section may be optimized for directing the sound output of the higher frequency transducer without enlarging the baffle of the drive unit. In other words, the present loudspeaker drive unit achieves great directivity with a small form factor.

Additionally, the use of a compression driver enables placing the opening of the throat and, thus, the higher frequency transducer at a greater distance from the lower frequency diaphragm. This, in turn, minimizes or even eliminates a reflective surface traditionally formed by the diaphragm of a conventional domed tweeter placed inside a relatively short throat. It follows that the drive unit may such constructed may achieve a flatter sound output curve with fewer peaks or dips caused by the tweeter reflections.

### BRIEF DESCRIPTION OF THE DRAWINGS

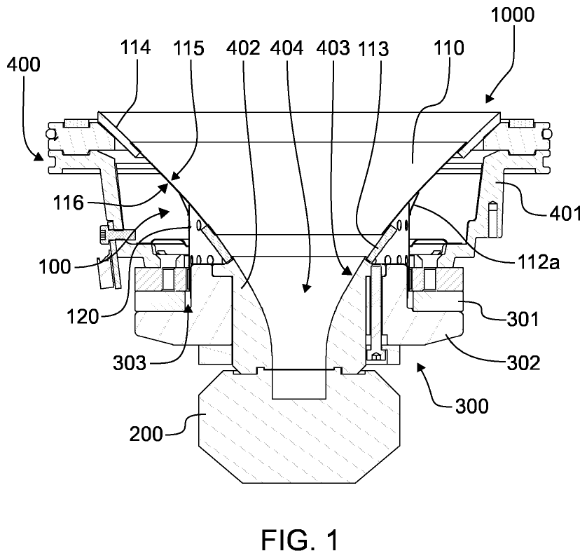

In the following exemplary embodiments are described in greater detail with reference to the accompanying drawings in which FIG. 1 illustrates a cross-sectional view of a loudspeaker drive unit in accordance with at least some embodiments.

### EMBODIMENTS

FIG. 1 shows a loudspeaker drive unit 1000 according to an exemplary embodiment isolated from an enclosing loudspeaker enclosure (not shown). The drive unit 1000 includes a frame 400 that acts as rigid reference for the moving parts of the drive unit as well as houses a magnetic circuit 300. The present example illustrates a compound drive unit 1000 hosting two transducers, namely a lower frequency transducer 100 for producing a mid- and/or low-frequency band and a higher frequency transducer 200 for producing a high frequency band. Such transducers 100, 200 are generally referred to as a mid-range driver and a tweeter, respectively. The lower frequency transducer 100 is a cone diaphragm assembly in the general sense of loudspeaker construction. The higher frequency transducer 200 is a compression driver in the general sense of loudspeaker construction as shown.

In the illustrated example the transducers 100, 200 share an acoustic axis, which makes the drive unit 1000 a coaxial driver unit. Alternatively, the transducers 100, 200 could be offset so as to include two distinct acoustic axes that could be parallel or tilted in respect to one another. The coaxial construction is, however, preferred for the sake of directivity. The orientation of the acoustic axis of the transducers 100, 200 or, in the case of a coaxial unit, the entire drive unit 1000 is defined by the direction of motion experienced by the diaphragm of the diaphragm assembly. This direction is, in turn, defined by the dimension of reciprocal motion experienced by the voice coil assembly 120 driving the diaphragm 110 of the lower frequency transducer 100. The acoustic axis should be understood to refer to the intended main primary direction of sound propagation of the drive unit and/or the pursued axis of symmetry of the produced sound pattern. The acoustic axis could alternatively be understood as an axis on which the sum of the sound output of the drive unit is most ideal. Typically the acoustic axis is the designed listening axis of the loudspeaker. The acoustic axis may be, but need not be, the axis of symmetry of the lower frequency transducer 100.

The diaphragm 110 of the lower frequency transducer 100 is attached to the frame between an outer frame section 401 and an inner frame section 402 of the frame 400. The outer frame section 401 will attach the drive unit 1000 to an enclosing enclosure, such as a loudspeaker cabinet or a wall in a flush installation setup or another receiving structure. The inner frame section 402 houses the higher frequency diaphragm assembly 200. A magnetic circuit 300 is attached to the frame 400 between the outer and inner sections 401, 402. The magnetic circuit 300 includes a magnet 303 and a surrounding center pole 301 with an annular gap 303 there between.

The diaphragm assembly of the lower frequency transducer 100 is suspended to the outer frame section 401 by means of an outer suspension element 114. The outer suspension element 114 surrounds the diaphragm 110 and connects it to the frame 400 of the drive unit 1000 in a flexible manner so as to allow the diaphragm 110 to experience axial reciprocal translation, i.e. forth to back movement in a direction parallel to the acoustic axis. In other words, the outer suspension element 114 is a flexible structure allowing the diaphragm 110 to move repeatedly in the primary acoustical direction of the drive unit 1000 and to return to the rest position after being deviated by the voice coil in the primary acoustical direction. The suspension element is, in other words, not directly driven by the voice coil. The outer suspension element 114 may be constructed as an annular member. Suitable materials include rubbers, foam plastics or Styrofoam, fabrics, particularly conditioned fabrics, thermoplastic elastomers, urethanes, and silicones. The outer suspension element 114 may be constructed from the same material as the primary vibrating diaphragm 110 but relieved or otherwise constructionally altered so as to provide elasticity to allow for the translation of the diaphragm 110. Regardless of the construction and material of the outer suspension element 114 its task is to allow the intended travel of the diaphragm 110. Accordingly, it is preferred that the outer suspension element 114 is constructed to allow the axial translation of the diaphragm 110, to support the diaphragm 110 in the radial dimension so as to prevent tilt, to seal the inner side of the diaphragm 110 from the outer side so as to prevent an acoustic short circuit, and/or to provide a returning force for returning the diaphragm to the position of rest of the diaphragm 110.

The diaphragm 110 exhibits a frusto-conical shape as understood in the field. As shown in FIG. 1, which represents a cross-section is taken along the acoustic axis, the sectional shape of the diaphragm 110 that extends away from the acoustic axis over a contour which comprises a component in the direction of the acoustic axis as well as in a direction transversal to the acoustic axis. In other words, the diaphragm 110 is an annular disc extending in the radial dimension when viewed in a cross-sectional plane taken along the acoustic axis of the diaphragm assembly. In the present context the term “radial” refers to a dimension or contour extending from the acoustic axis of a diaphragm assembly along a straight or curved path in any angle excluding 0 and 180 angles in respect to the acoustic axis. The radial dimension is therefore defined by a path formed by successive points of a diaphragm 110 extending away from the acoustic axis towards the outer rim of the diaphragm 110 when viewed in a cross-section taken along the acoustic axis. Accordingly it may be seen that because the imaginary extensions of the cross-sectional shape of the diaphragm converge on the acoustic axis of the diaphragm assembly, e.g. at the same point on the acoustic axis, the flaring shape of the diaphragm 110 may be said to be radial.

As mentioned above, the diaphragm 110 exhibits a generally frusto-conical shape. In the present context the term “conical” refers not only to mathematical cones but is to be understood so as to also refer to cones as understood in the field of loudspeaker construction. Accordingly the expression also includes curved diaphragms and rotationally non-symmetrical diaphragms and frusto-conical versions of the same. Accordingly, the suspension elements 113, 114 and the diaphragm 110 are tangentially aligned for creating a continuous outer surface for the diaphragm assembly formed by the suspension elements 113, 114 and the diaphragm 110. In the present context the term “continuous” refers not only to mathematical continuity but is to be understood so as to refer to a surface meant in the field of loudspeaker construction to including surfaces exhibiting small axial deviations that bear little, i.e. non-measurable, or no significance to the output of the diaphragm assembly or drive unit. This is to say that the suspension elements 113, 114 and the diaphragm 110 flare to the same direction. It is of course possible that there is slight deviation in the tangential alignment of the respective shapes. For example, FIG. 2 shows a small ridge at the seam between the suspension elements 113, 114 and the diaphragm 110. Such a small ridge would in theory create a tangential misalignment but it is to be disregarded for being minute, i.e. for not creating measurable significance to the sound output. By having a continuously outwardly flaring diaphragm assembly, the baffle forms an effective waveguide for high frequencies produced by the higher frequency transducer 200.

The diaphragm has an outer side 115 for sound propagation along the acoustic axis X of the diaphragm assembly 100 and an inner side 116 opposing the outer side 115. The voice coil assembly 120 is attached to the inner side 116 of the diaphragm 110. More particularly, the voice coil assembly 120 is attached to the inner perimeter 112a of the diaphragm 110. The voice coil assembly 120 is also suspended to the drive unit frame 400 and aligned to the magnetic air gap 303 by means of a spider.

The inner frame section 402 of the frame 400, which acts as a mounting point for the center edge of the diaphragm 110, also houses a higher frequency transducer 200. The inner frame section 402 includes an opening 404, which is defined by throat 403, which is the surface visible to the outside. The opening 404 provides an acoustic passageway for the output of the higher frequency transducer 200. The output opening of the higher frequency transducer 200 is aligned with the opening 404 of the inner frame section 402. Accordingly, making the compound drive unit 1000 coaxial.

The higher frequency transducer 200 is a compression driver.

The higher frequency transducer 200 is mounted to the rear of the inner frame section 402. It follows that the front-most point of the higher frequency transducer 200 is behind the rear-most point of the diaphragm 110 of the lower frequency transducer 100, when viewed along the acoustic axis of the drive unit 1000. The distance between the higher frequency transducer 200 and the lower frequency transducer 100 along the acoustic axis may be equal to or more than the axial extension of the diaphragm 110 of the lower frequency transducer 100, when viewed along the acoustic axis of the drive unit 1000. Accordingly, the throat 403 is noticeably deep compared to traditional compound drive units.

The throat 403 is shaped to be tangentially aligned with the diaphragm assembly. This means that the throat 403, the suspension elements 113, 114, and the diaphragm 110 form essentially continuous surface, which forms a waveguide for soundwaves that originate from the higher frequency transducer 200. Accordingly, the throat 403 may exhibit an outwardly flaring waveguide surface when viewed along the acoustic axis of the higher frequency transducer 200. The waveguide surface is preferably as smooth and continuous as possible so as to minimize diffraction of sound. Accordingly, it is preferable to align the components of the waveguide, namely the throat 403, the suspension elements 113, 114, and the diaphragm 110, tangentially. In particular, the waveguide surface preferably contains no considerable lips or other protrusions that would break the continuity. If possible, all seams along the waveguide surface are preferably perfected to exhibit axial deviations no greater than 1 mm.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

REFERENCE SIGNS LIST

| NO. | ELEMENT |
|---|---|
| 100 | lower frequency transducer |
| 110 | diaphragm |
| 113 | inner suspension element |
| 114 | outer suspension element |
| 115 | outer side |
| 116 | inner side |
| 120 | voice coil assembly |
| 200 | higher frequency transducer |
| 300 | magnetic circuit |
| 301 | magnet |
| 302 | center pole |
| 303 | gap |
| 400 | frame |
| 401 | outer frame section |
| 402 | inner frame section |
| 403 | throat |
| 404 | opening |
| 1000 | drive unit |

1. A loudspeaker drive unit comprising:
a frame, which frame comprises an outer frame section and an inner frame section, which inner frame section comprises an opening and a throat, which throat forms part of a waveguide,
a lower frequency transducer, which lower frequency transducer comprises a diaphragm, which diaphragm is suspended between the outer frame section and the inner frame section with an outer suspension element and an inner suspension element, respectively, so as to form part of the waveguide, and
a higher frequency transducer attached to the inner frame section wherein:
the higher frequency transducer is a compression transducer, and in that
the higher frequency transducer is mounted to the rear of and behind the inner frame section, when viewed along the acoustic axis of the drive unit.

2. The loudspeaker drive unit according to claim 1, wherein the throat defines the opening.

3. The loudspeaker drive unit according to claim 1, wherein an output opening of the higher frequency transducer is aligned with the opening of the inner frame section.

4. The loudspeaker drive unit according to claim 1, wherein the throat comprises a surface, which forms part of the waveguide.

5. The loudspeaker drive unit according to claim 1, wherein the outer suspension element and the inner suspension element, which suspend the diaphragm of the lower frequency transducer to the frame, form part of the waveguide.

6. The loudspeaker drive unit according to claim 1, wherein the outer suspension element and the inner suspension element are not directly driven by a voice coil.

7. The loudspeaker drive unit according to claim 1, wherein the throat, the suspension elements, and the diaphragm are tangentially aligned.

8. The loudspeaker drive unit according to claim 1, wherein the throat exhibits an outwardly flaring waveguide surface.

9. The loudspeaker drive unit according to claim 1, wherein the waveguide surface is continuous with no axial protrusions exceeding 1 mm.

10. The loudspeaker drive unit according to claim 1, wherein distance between the higher frequency transducer and the lower frequency transducer along the acoustic axis is equal to or more than the axial extension of the diaphragm of the lower frequency transducer along the acoustic axis of the drive unit.

11. The loudspeaker drive unit according to claim 1, wherein the acoustic axes of the higher frequency transducer and lower frequency transducer are aligned.
